(19) United States
(12) Patent Application Publication
(10) Pub. No.: US 2010/0001187 A1
(43) Pub. Date: Jan. 7, 2010

(54) HEADWEAR-MOUNTABLE SITUATIONAL AWARENESS UNIT

(75) Inventors: Kurt James Fenske, Gleason, WI (US); Thomas Kent Guelzow, II, Eau Claire, WI (US)

Correspondence Address: MERCHANT & GOULD PC, P.O. BOX 2903, MINNEAPOLIS, MN, 55402-0903, US

(73) Assignee: REX SYSTEMS, INC., Chippewa Falls, WI (US)

(21) Appl. No.: 12/166,480

(22) Filed: Jul. 2, 2008

(51) Int. Cl. G02F 1/01

(52) U.S. Cl. 250/330

(57) ABSTRACT

A headwear-mountable situational awareness unit is disclosed. The unit includes a thermal imaging camera rotatably connected to a mounting portion, the mounting portion connectable to a front portion of protective headgear. The unit further includes a heads-up display pivotally connected to the mounting portion, the heads-up display portion arranged to pivot between a mounted position and a handheld position and configured to display information captured by the thermal imaging camera.

### TECHNICAL FIELD

The present disclosure relates generally to situational awareness enhancement equipment. More specifically, the present disclosure relates to a headwear-mountable situational awareness unit.

### BACKGROUND

Fires, explosions, and other catastrophic events require the action of trained first responders and other emergency responders, including the police department, fire department, and appropriate medical responders. During such events, conditions such as flying/falling debris, smoke, gases, open fires, or other hazardous conditions are likely to be present. These conditions present a hazard to first responders, and can hinder response efforts due to their interference with visual and audio communications between responders.

In many emergency response situations, safety devices, such as head safety devices, helmets, and portable breathing apparatus, are used to protect the emergency responders and others from a variety of hazardous conditions often occurring at an emergency site. A portion of such equipment will generally block some of the periphery of a first responder's visual field.

In emergency situations, protection equipment further limits a user's vision, because the equipment combines with smoke, dust, or other conditions at the emergency site to block a large amount of the user's field of view. In a specific example, a helmet can block a user's field of vision when that user's head is down, such as in the case of a firefighter or other first responder crawling through a smoke- or dust-filled area. In certain cases, that user's vision is obscured to the point that he/she cannot see hazards or other individuals directly in front of them.

For these and other reasons, improvements are desirable.

### SUMMARY

According to the following disclosure, the above and other problems are solved by the following:

In a first aspect, a headwear-mountable situational awareness unit is disclosed. The unit includes a thermal imaging camera rotatably connected to a mounting portion, the mounting portion connectable to a front portion of protective headgear. The unit further includes a heads-up display pivotally connected to the mounting portion, the heads-up display portion arranged to pivot between a mounted position and a handheld position and configured to display information captured by the thermal imaging camera.

In a second aspect, a method of operation of a situational awareness unit is disclosed. The method includes directing a thermal image camera toward an area in front of a user, the thermal image camera rotatably connected to a mounting portion mounted on protective headgear worn by the user. The method also includes capturing a thermal image of the area in front of the user with the thermal image camera. The method further includes displaying information relating to the thermal image in a heads-up display connected to the mounting portion.

In a third aspect, a headwear-mountable situational awareness unit is disclosed. The unit includes a mounting portion connectable to a front portion of protective headgear and including a housing, the mounting portion enclosing circuitry and defining a communications port connectable to an external communications module. The unit also includes a thermal imaging camera connected to the mounting portion, the thermal imaging camera manually rotatable with respect to the mounting portion. The unit further includes a heads-up display pivotally connected to the mounting portion, the heads-up display portion arranged to pivot at least between a mounted position and a handheld position and configured to display information captured by the thermal imaging camera.

### BRIEF DESCRIPTION OF THE DRAWINGS

FIG. 1 is a perspective view of a headwear-mountable situational awareness unit mounted to a piece of protective headwear, according to a possible embodiment of the present disclosure;

FIG. 2 is a front perspective view of the headwear-mountable situational awareness unit of FIG. 1, mounted to a piece of protective headwear;

FIG. 3 is a side perspective view of the headwear-mountable situational awareness unit of FIG. 1, mounted to a piece of protective headwear;

FIG. 4 is a top perspective view of the headwear-mountable situational awareness unit of FIG. 1, mounted to a piece of protective headwear;

FIG. 5 is a perspective view of the headwear-mountable situational awareness unit of FIG. 1 in an adjusted position;

FIG. 6 is a front perspective view of the headwear-mountable situational awareness unit of FIG. 1 in an adjusted position;

FIG. 7 is a side perspective view of the headwear-mountable situational awareness unit of FIG. 1 in an adjusted position;

FIG. 8 is a top perspective view of the headwear-mountable situational awareness unit of FIG. 1 in an adjusted position;

FIG. 9 is a perspective view of the headwear-mountable situational awareness unit of FIG. 1;

FIG. 10 is a front plan view of the headwear-mountable situational awareness unit of FIG. 9;

FIG. 11 is a rear plan view of the headwear-mountable situational awareness unit of FIG. 9;

FIG. 12 is a side plan view of the headwear-mountable situational awareness unit of FIG. 9;

FIG. 13 is a top plan view of the headwear-mountable situational awareness unit of FIG. 9;

FIG. 14 is a perspective view of the headwear-mountable situational awareness unit of FIG. 1, in an adjusted position;

FIG. 15 is a front plan view of the headwear-mountable situational awareness unit of FIG. 14;

FIG. 16 is a rear plan view of the headwear-mountable situational awareness unit of FIG. 14;

FIG. 17 is a side plan view of the headwear-mountable situational awareness unit of FIG. 14;

FIG. 18 is a top plan view of the headwear-mountable situational awareness unit of FIG. 14;

FIG. 19 is a perspective view of the headwear-mountable situational awareness unit of FIG. 1, in a stowable position;

FIG. 20 is a front plan view of the headwear-mountable situational awareness unit of FIG. 19;

FIG. 21 is a rear plan view of the headwear-mountable situational awareness unit of FIG. 19;

FIG. 22 is a side plan view of the headwear-mountable situational awareness unit of FIG. 19;

FIG. 23 is a top plan view of the headwear-mountable situational awareness unit of FIG. 19;

FIG. 24 is a perspective view of a thermal imaging camera useable in the headwear-mountable situational awareness unit of FIG. 1, in a handheld position;

FIG. 25 is a front plan view of the thermal imaging camera of FIG. 24;

FIG. 26 is a side plan view of the thermal imaging camera of FIG. 24;

FIG. 27 is a rear plan view of the thermal imaging camera of FIG. 24;

FIG. 28 is a top plan view of the thermal imaging camera of FIG. 24;

FIG. 29 is a block diagram of functional components of a headwear-mountable situational awareness unit, according to a possible embodiment of the present disclosure;

FIG. 30 is a schematic view of a heads-up display according to a possible embodiment of the present disclosure;

FIG. 31 illustrates an example user interface of a heads-up display integrated with a thermal imaging camera in a headwear-mountable situational awareness unit, according to a possible embodiment of the present disclosure;

FIG. 32 illustrates an example network in which one or more headwear-mountable situational awareness units can be used, according to a possible embodiment of the present disclosure;

FIG. 33 illustrates a further example network in which one or more headwear-mountable situational awareness units can be used, according to a possible embodiment of the present disclosure;

FIG. 34 is a block diagram of a generalized computing system usable to implement aspects of the present disclosure;

FIG. 35 illustrates a flowchart of methods and systems of use relating to a headwear-mountable situational awareness unit, according to a possible embodiment of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting, and merely set forth some of the many possible embodiments for the appended claims.

The present disclosure, in general, is related to a headwear-mountable situational awareness unit. The unit can be mounted onto a front brim portion of a safety helmet, such as are worn by firefighters or other first response personnel. The unit can also be used in a handheld, manual operation arrangement. The unit allows vision of events even when vision would normally be obscured due to adjustable placement of a thermal image camera and use of a heads-up display.

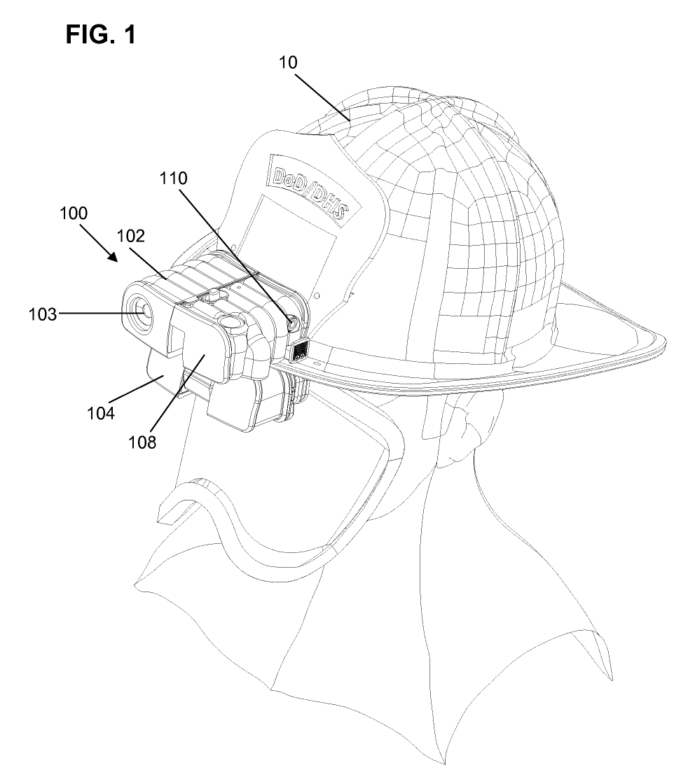

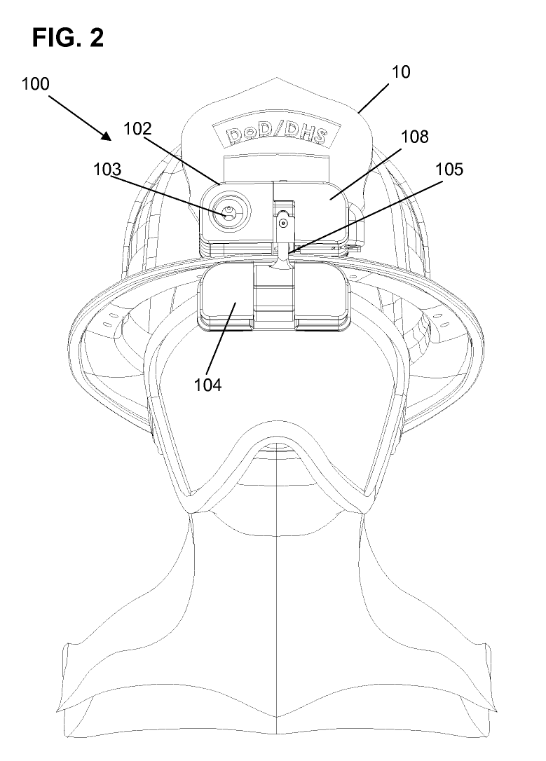

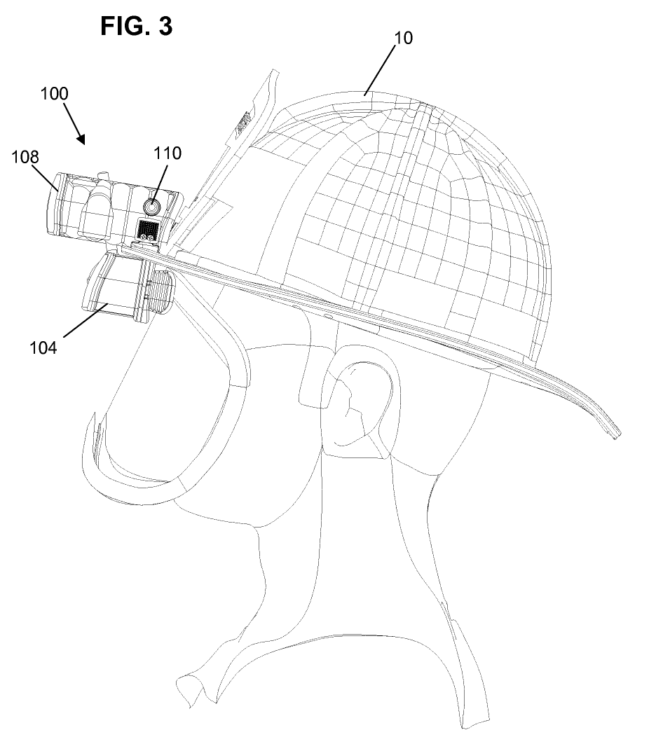

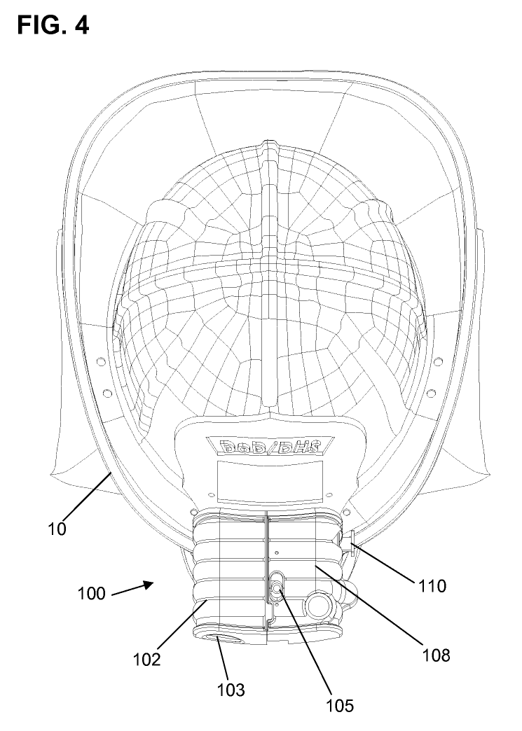

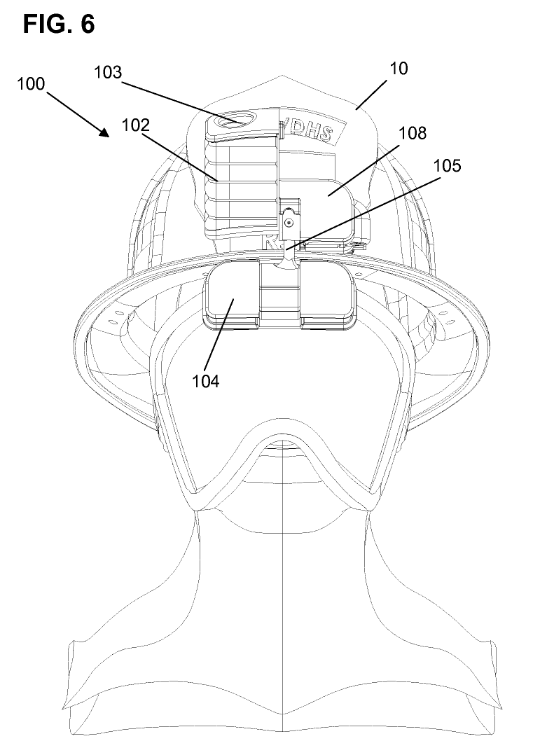

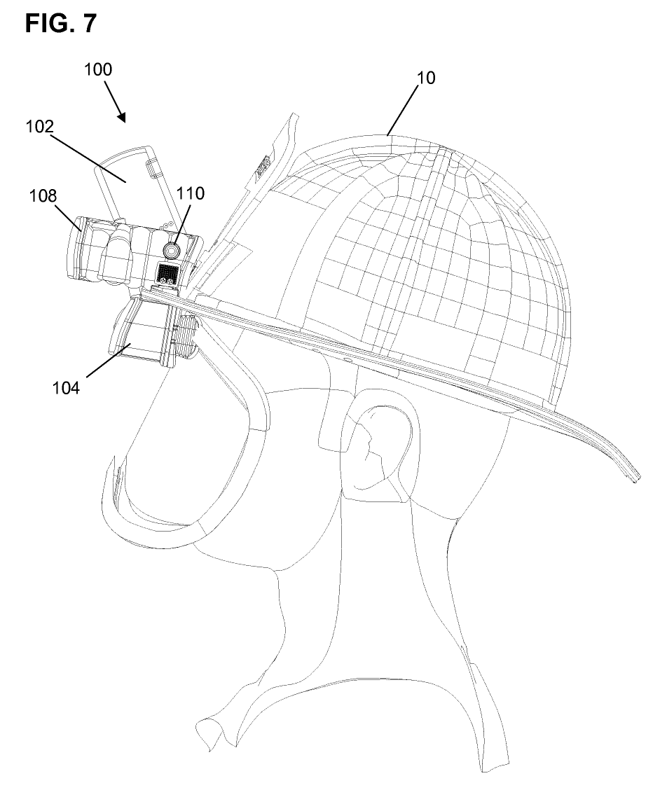

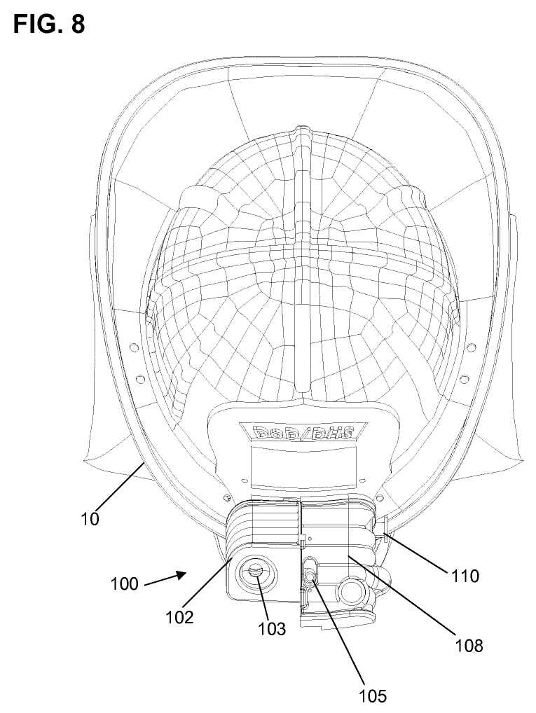

Referring now to FIGS. 1-8, a headwear-mountable situational awareness unit 100 is shown mounted on a piece of protective headwear, shown as a firefighter's helmet 10. The unit 100 is generally environmentally resilient, and has a housing that can be manufactured from a plastic or metal alloy. The unit 100 generally includes a thermal imaging camera 102 and a heads-up display 104.

The thermal imaging camera 102 is configured to capture thermal images and other temperature-related information about its surrounding environment. In the embodiment shown, the thermal imaging camera 102 is positioned above a brim of the firefighter's helmet 10, and includes an aperture 103 directed outwardly from the helmet for capturing thermal images. The heads-up display 104 presents information to a user, such that the user of the heads-up display can view that information concurrently with viewing objects in a natural field of view of that user. The information can include, in certain embodiments, information such as thermal images or other temperature-related information captured by the thermal imaging camera 102.

In various embodiments, the headwear-mountable situational awareness unit 100 can include a binocular or monocular heads-up display, and associated thermal image camera 102. In the embodiment shown, the headwear-mountable situational awareness unit 100 includes a heads up display 104 that has a binocular viewfinder 106. The binocular viewfinder 106 allows a user to view images with both eyes, and preferably includes a flexible perimeter portion that is contoured to fit a face of a user, to conform to a face shield worn by the user when the unit 100 is configured in a mountable position, or to seal across the aperture 103 when in a stowable position. Other configurations are possible as well.

The thermal imaging camera 102 and heads-up display 104 are connected to a mounting portion 108, which is mountable to headwear, such as the firefighter's helmet 10 shown. The mounting portion 108 connects the headwear-mountable situational awareness unit 100 to a piece of headwear by any of a number of different methods, including use of a connection bracket, fasteners, pressure-connection, or other methods.

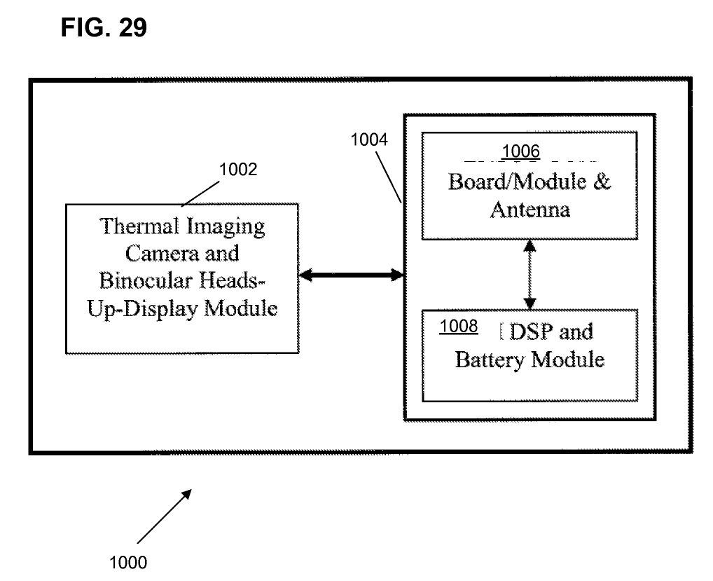

The mounting portion 108 has a housing that can include, in various embodiments, a variety of types of electronic circuitry, such as a battery pack and other signal processing circuitry. In the embodiment shown, the mounting portion includes a communication port 110, which allows connection of the headwear-mountable situational awareness unit 100 to external systems, such as a communications unit that allows data and voice communications with external computing systems or telecommunications devices. Details regarding example circuitry included in or connectable to the headwear-mountable situational awareness unit 100 are described in conjunction with FIG. 29, below.

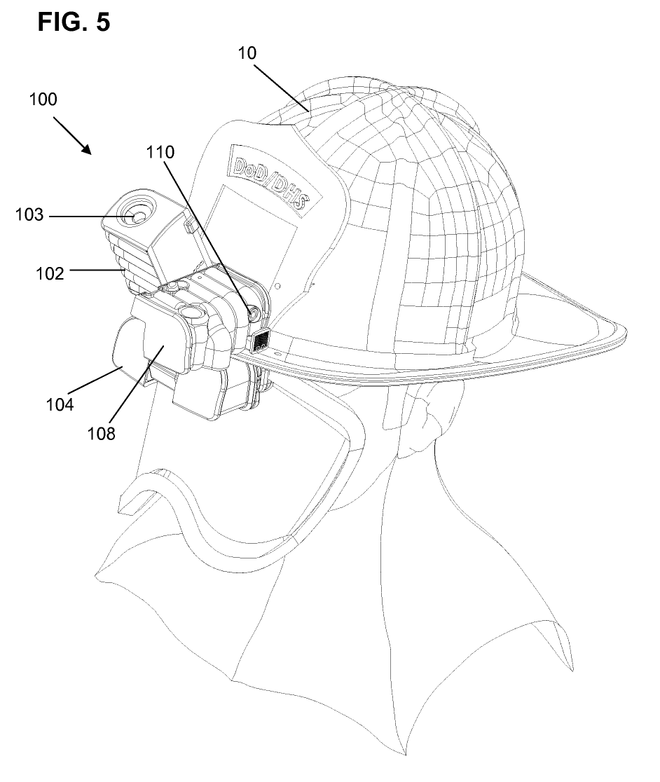

The thermal imaging camera 102 is rotatably connected to the mounting portion 108 along a side portion of the camera, such that the camera is rotatable along a vertical arc of approximately ninety degrees. Using such a camera, a user wearing the helmet 10 or other protective headwear having the unit 100 mounted thereon can manually adjust the position of the camera 102 such that it is directed forward from the user, regardless of the head position of that user. For example, in certain situations, a user of the headwear-mountable situational awareness unit 100 will be in a crawling position, facing the floor. The user can manually readjust the position of the thermal imaging camera 102 such that it faces straight ahead of the user (e.g. as seen in FIGS. 5-8), thereby providing a viewable thermal image on the heads-up display 104 even when no direct sight is available.

The heads-up display 104 is pivotally connected to the mounting portion by a hinged arm assembly 105, and swings through an arc of approximately 180 degrees between a mountable position, a stowable position, and a manually-operable position, as described below. In use, the headwear-mountable situational awareness unit 100 can be used either mounted on a piece of headwear (e.g. the firefighter's helmet 10 or other headwear) or manually operated. In a manually-operated mode, the headwear-mountable situational awareness unit 100 is detached from headwear and held by the user, e.g. by holding the heads-up display 104 within their field of vision for viewing the information displayed. The unit 100 is generally contoured to fit in the hand of a user. In the embodiment shown, the unit 100 has a ribbed housing allowing the user to grip the unit during manual operation.

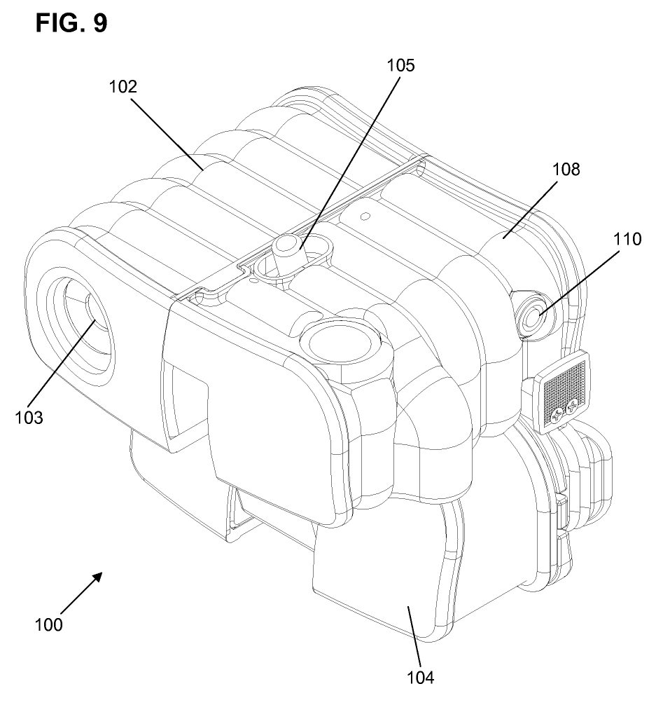

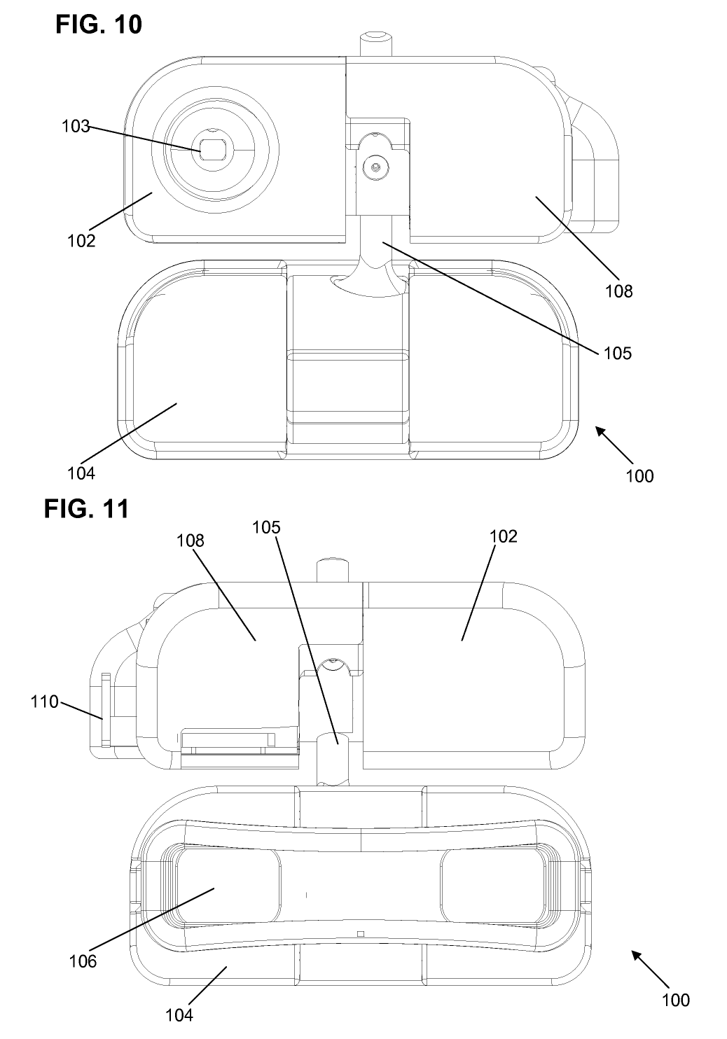

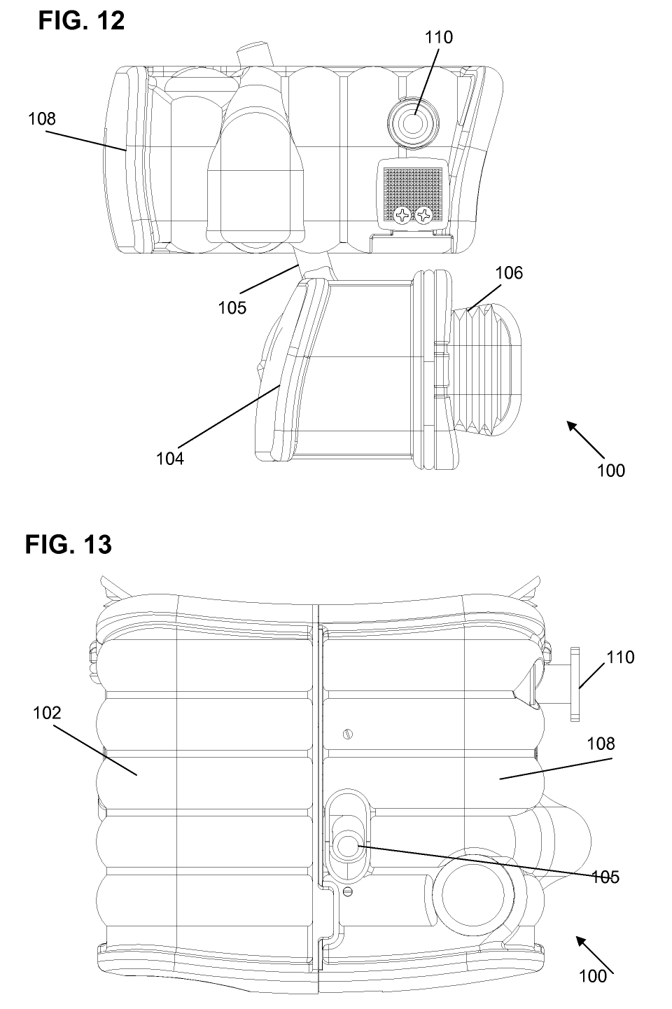

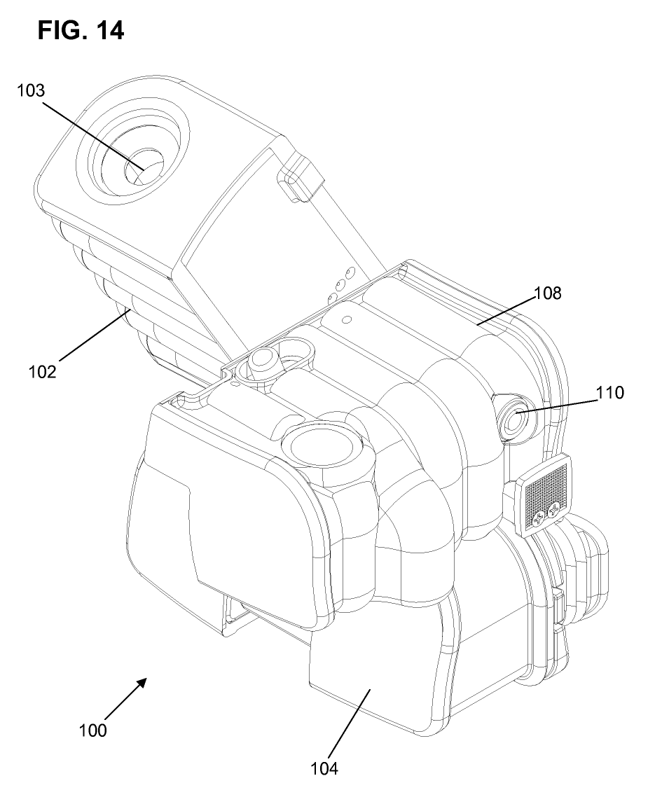

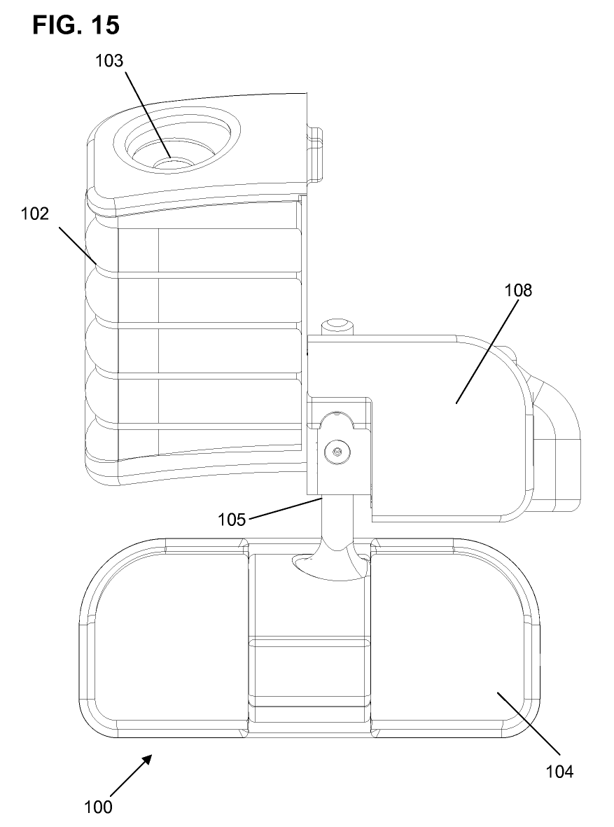

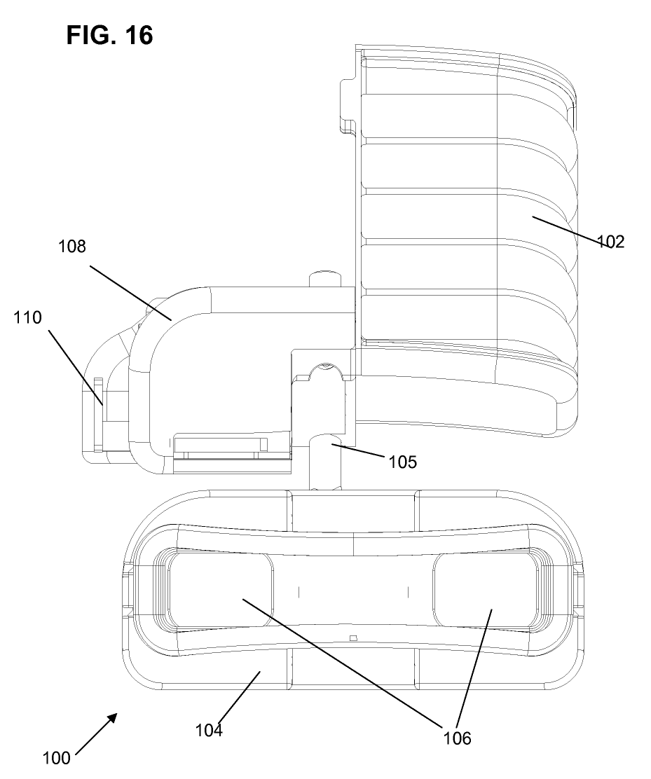

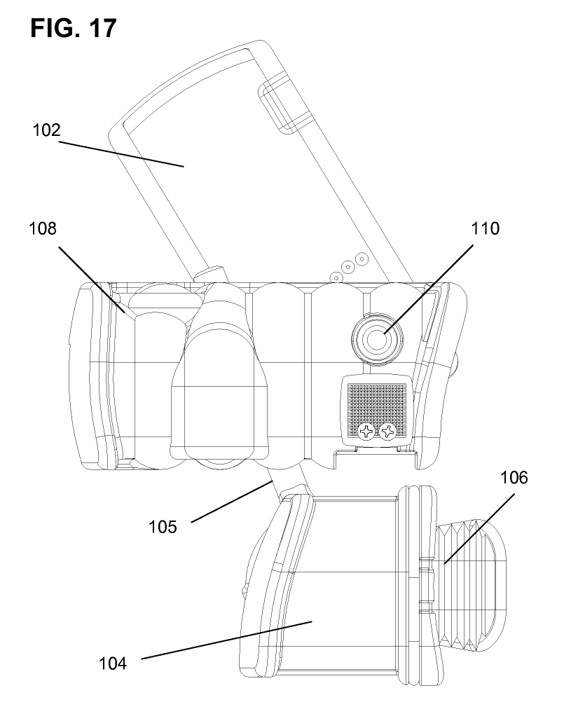

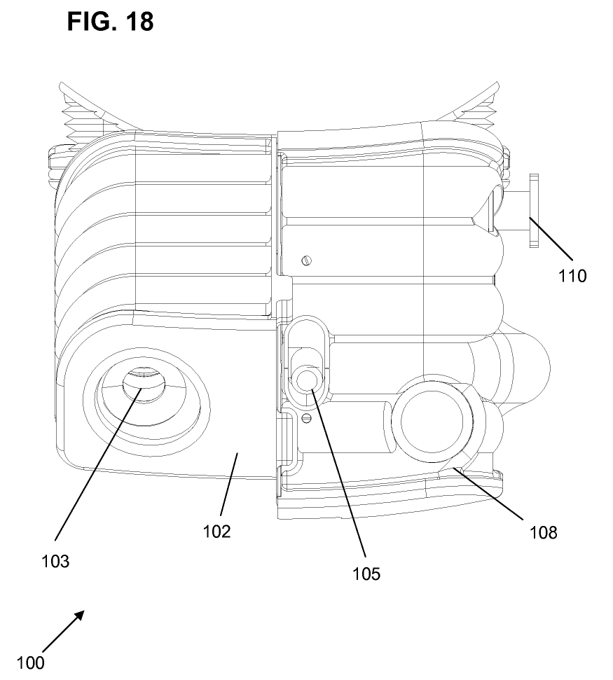

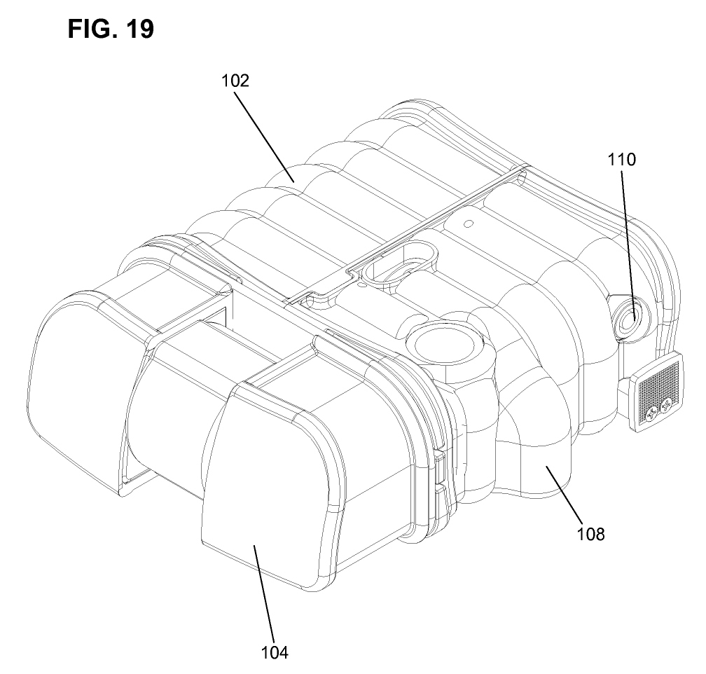

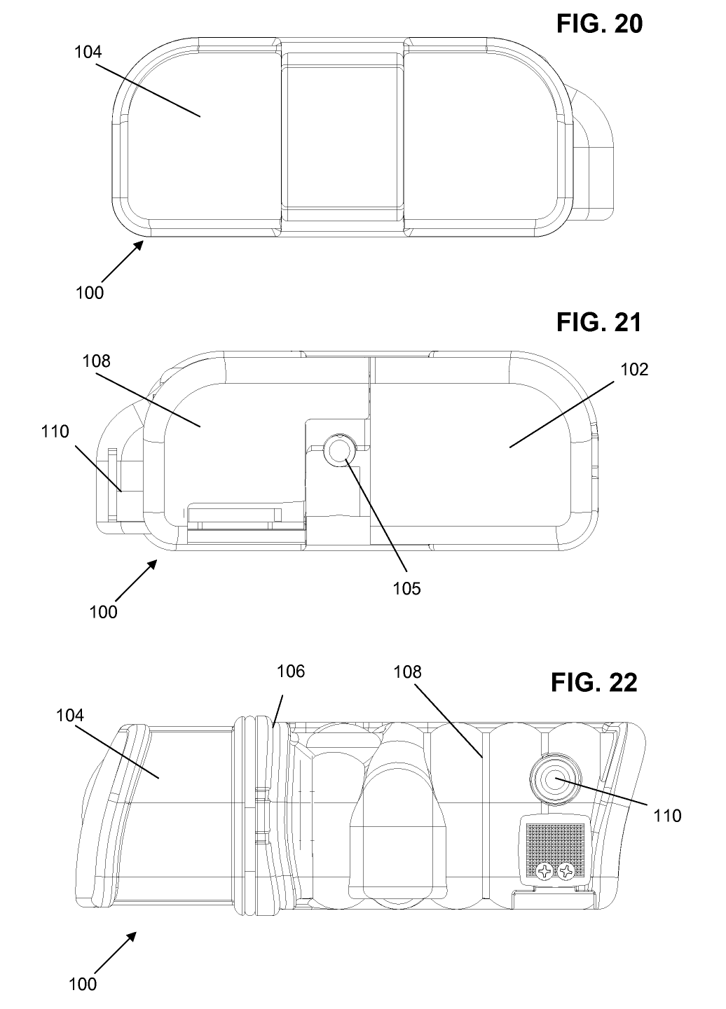

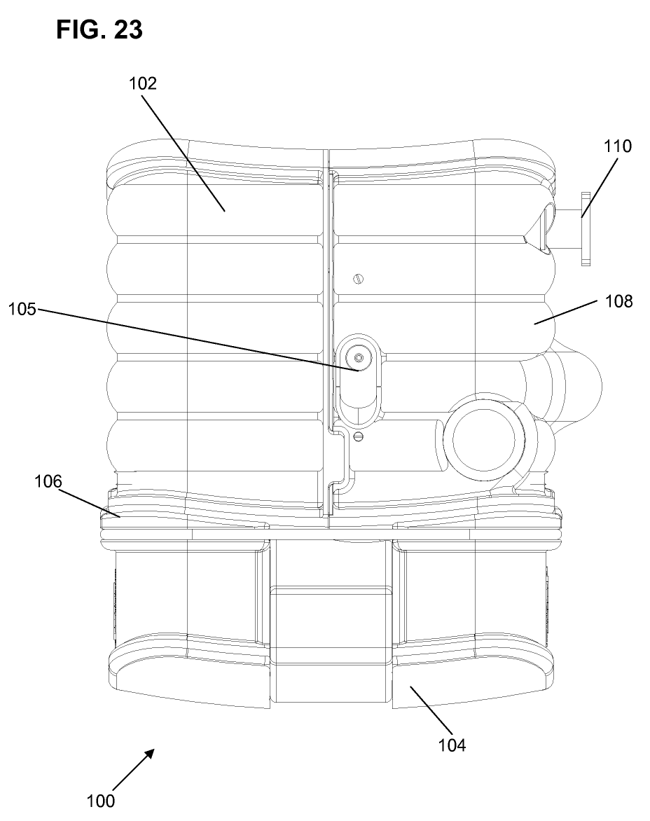

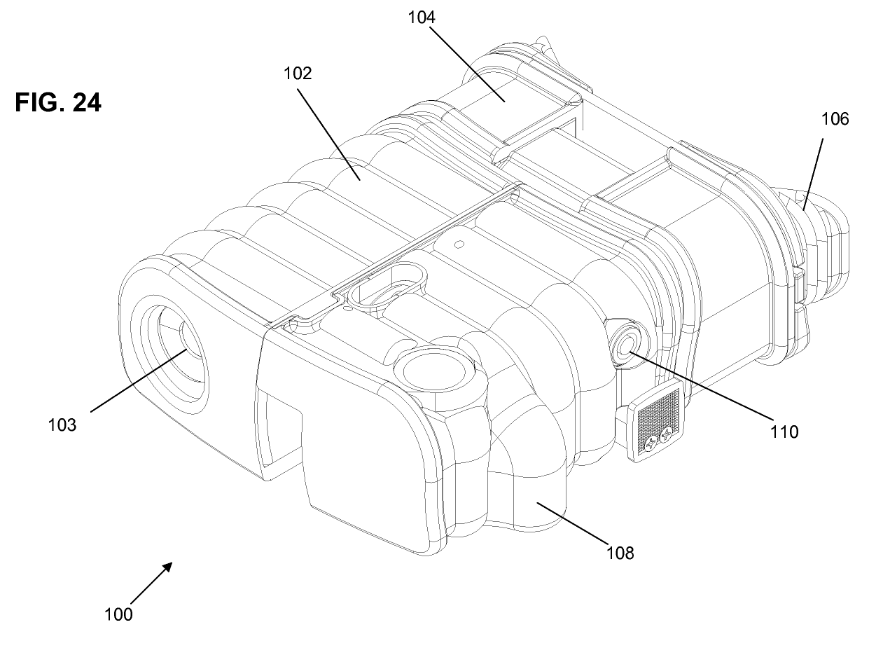

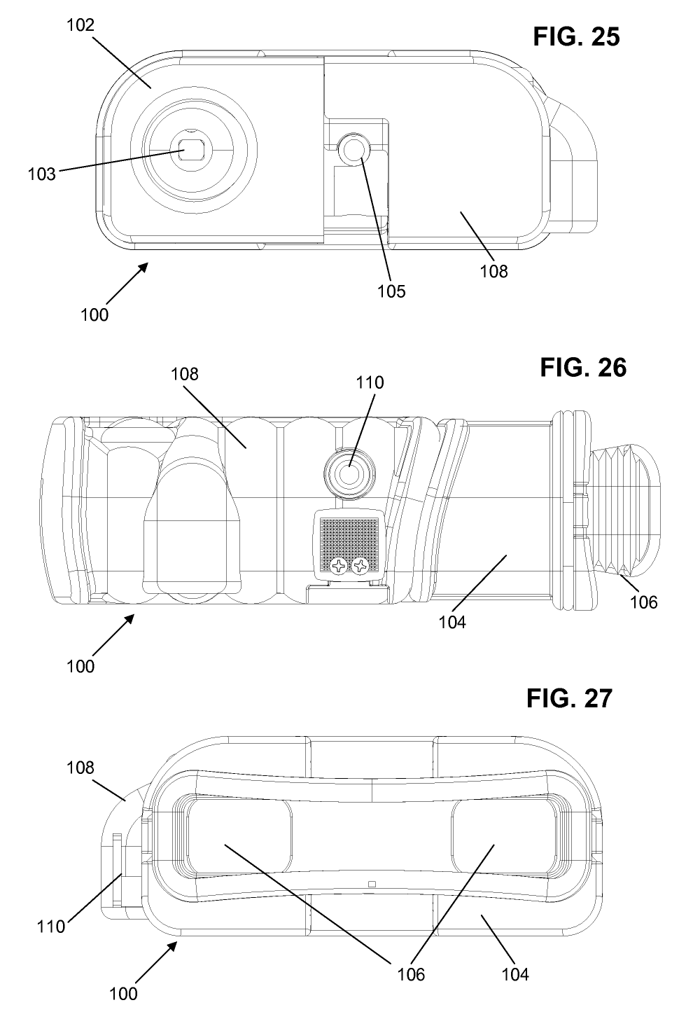

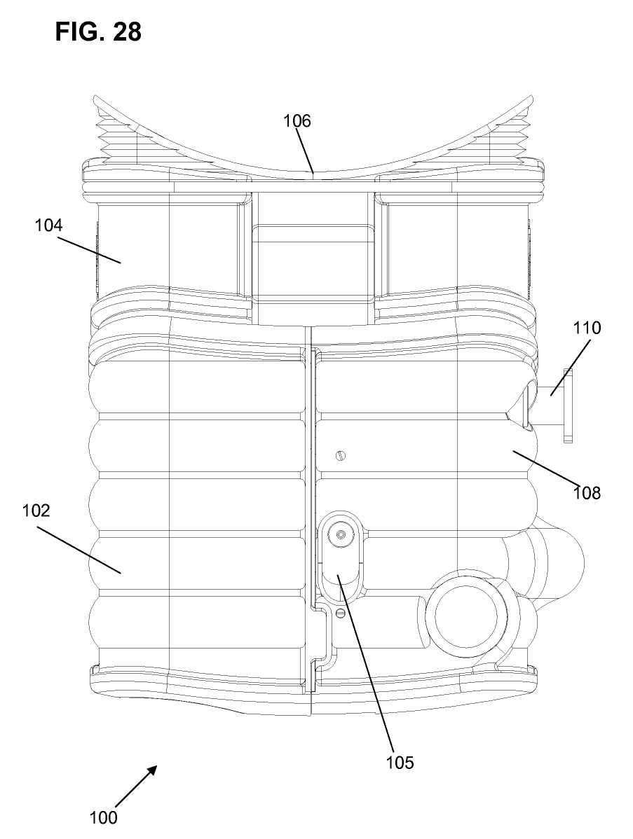

Rotational positioning of the headwear-mountable situational awareness unit 100 in various applications is described in greater detail now in conjunction with FIGS. 9-27, which illustrate various possible arrangements of the unit. Specifically, FIGS. 9-13 illustrate the headwear-mountable situational awareness unit 100 in a useable position, where the unit is mountable to headwear. FIGS. 14-18 illustrate the headwear-mountable situational awareness unit 100 in a rotated useable position, for crawling or otherwise viewing an area in front of a user while that user's head is oriented downward. FIGS. 19-23 illustrate the headwear-mountable situational awareness unit 100 in a closed position, allowing the unit to be stowed. FIGS. 24-28 illustrate the headwear-mountable situational awareness unit 100 in a handheld, manually operable position.

As can be seen in FIGS. 9-28, the headwear-mountable situational awareness unit 100 is movable between various useable positions and a stowable position. Specifically, the heads-up display 104 is pivotable through an approximately 180 degree arc between a mountable position, a manually useable position, and a stowable position. The heads-up display 104 remains oriented in generally a constant direction, such that in the stowable position (FIGS. 19-23), the viewfinder 106 faces the aperture 103 of the thermal imaging camera 102, while in the manually-operable position, the viewfinder 106 is located on an opposite side of the unit 100 from the aperture 103, and both are exposed for use. In the mountable position, the viewfinder 106 is generally oriented in a direction opposite that of the aperture 103, although the heads-up display 104 is positioned within a user's field of view and is generally not aligned with the thermal imaging camera 102 (which is generally positioned on the headwear).

When the headwear-mountable situational awareness unit 100 is in a useable position, the thermal imaging camera remains movable to allow viewing of thermal images in front of the user. The thermal imaging camera 102 is rotatable with respect to the mounting portion 108 (as illustrated in FIGS. 9-13 and FIGS. 14-18) when used in a mounting position, to allow viewing of thermal images captured in front of the user.

Additional axes of movement may be incorporated into the unit 100 as well, based on the needs of the user to adjust the position of the thermal imaging camera 102, the heads-up display 104, or the mounting position of the mounting portion 106.

FIG. 29 is a block diagram of an operational system 1000 of a headwear-mountable situational awareness unit, according to a possible embodiment of the present disclosure. The system 1000 includes, in the embodiment shown, a headwear-mountable situational awareness unit 1002, and a communications module 1004. The headwear-mountable situational awareness unit 1002 can, in various embodiments, correspond to the headwear-mountable situational awareness unit 100 of FIGS. 1-9; however, other similar units could be used as well. Generally, the headwear-mountable situational awareness unit 1002 includes a heads-up display and a thermal imaging camera; however, a number of other sensors and systems can be included as well. For example, in certain embodiments, the headwear-mountable situational awareness unit 1002 includes a temperature sensor as well, which can detect an ambient temperature near the unit and display that information to the user via the heads-up display, concurrently with the thermal image or other information.

The communications module 1004 includes a signal and power module 1006 and a communications module 1008. The signal and power module 1006 provides power to the headwear-mountable situational awareness unit 1002, as well as to the other components of the system 1000. In certain embodiments, the signal and power module 1006 includes a battery, such as a rechargeable battery. In other embodiments, the signal and power module 1006 receives an input power from an external power source, such as a separate battery pack, and provides power conditioning and regulation.

The signal and power module 1006 also provides signal processing capabilities to the system 1000, such as by preparing data captured received via the headwear-mountable situational awareness unit 1002 for transmission via the communications module 1008. The signal and power module 1000 can also interpret received communications signals from the communications module 1008 for display by a heads-up display of the headwear-mountable situational awareness unit 1002.

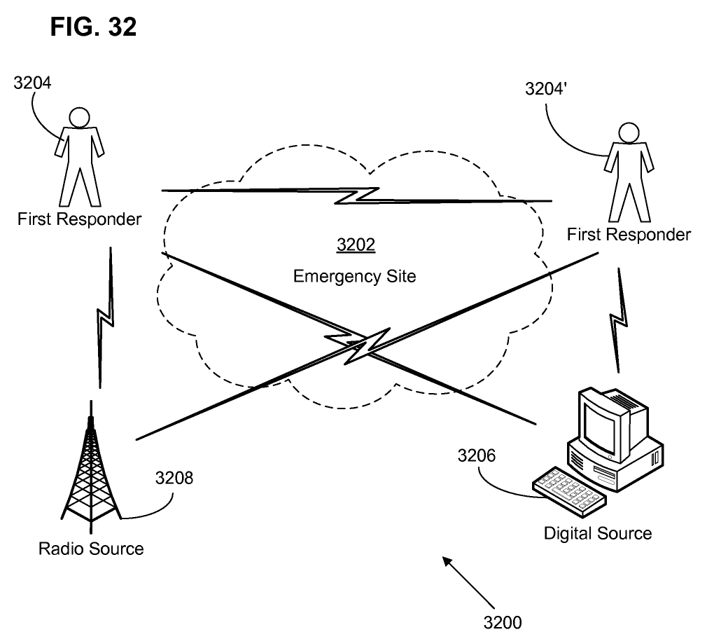

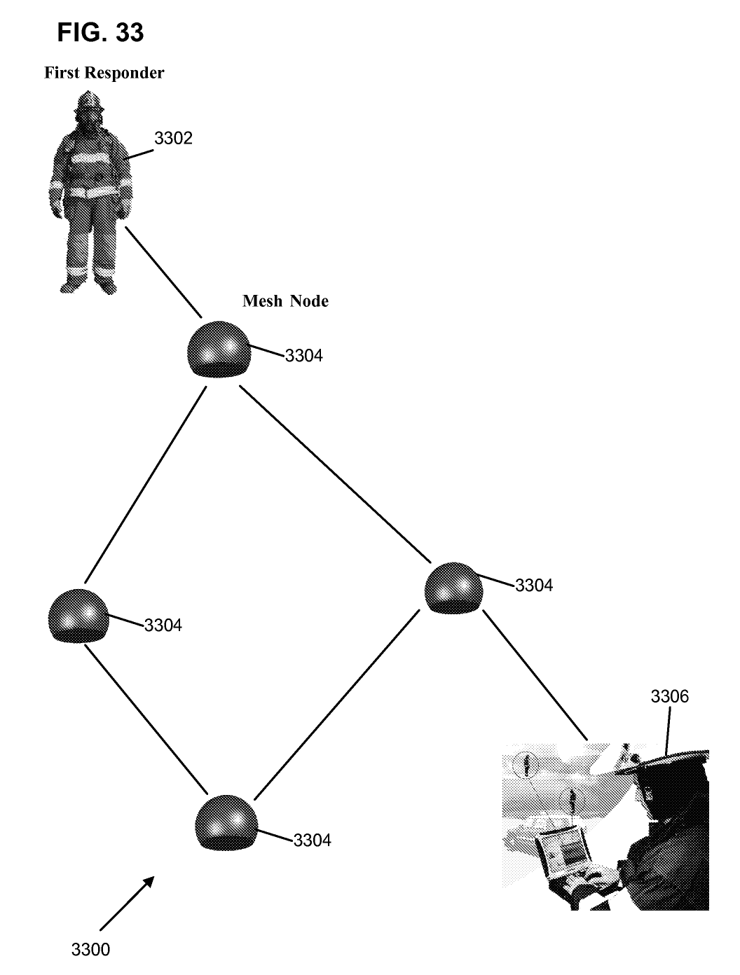

The communications module 1008 can include any of a number of types of communications modules capable of voice and/or data communication with other computing systems, telecommunications devices, or other systems. The communications module 1008 allows the system 1000 to communicate via a voice or data network, such as those described below in conjunction with FIGS. 32-33.

In certain embodiments, the signal and power module 1006 is also incorporated into the headwear-mountable situational awareness unit 1002. For example, the signal and power module 1006 can reside within a mounting portion (e.g. mounting portion 108 of FIGS. 1-28). In such embodiments, the signal and power module 1006 can be communicatively connected to the communications module via a communications port in the unit, as described above.

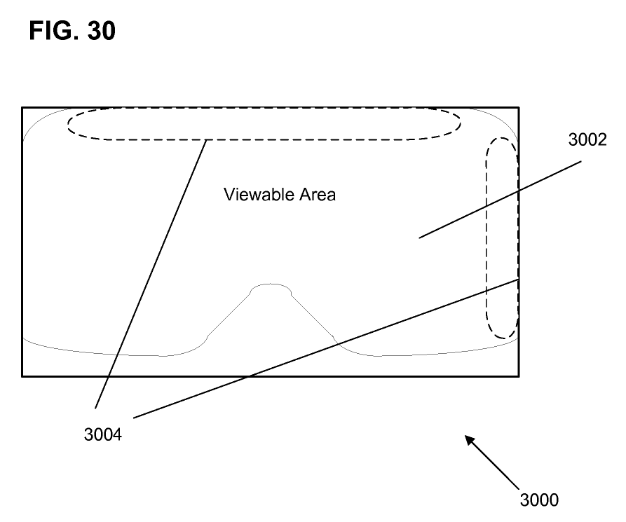

FIG. 30 is a schematic view of a field of view 3000 incorporating heads-up display according to a possible embodiment of the present disclosure. The field of view 3000 illustrates possible locations for heads up display components (e.g. as presented by a heads-up display of a headwear-mountable situational awareness unit) according to various embodiments of the present disclosure. The field of view 3000 illustrates a viewable area 3002 including one or more display regions 3004. The viewable area 3002 is limited by the view of the user, as further limited by protective equipment worn by the user. In the case of the headwear-mountable situational awareness unit 100 of FIGS. 1-28, the viewable area is limited by the brim of the protective headwear 10, and is limited at a lower portion by goggles or a face shield also worn by the firefighter or other first responder. In other situations, the viewable area is limited by facial features or protruding surfaces of a head protection device or other safety device with which the systems of the present disclosure are integrated.

The display regions 3004 provide a location at which a heads up display is projected, and are oriented such that the heads up display information is displayed along the bridge and side of the user's visual field. The displayed information in the display regions 3004 is readily available yet does not obstruct the normal vision of the wearer of the protective equipment. In one embodiment, one or more of the possible display regions 3004 are used. For example, display region 3004 at the upper portion of the viewable area 3002 can be used in the absence of the display region along the side of the viewable area 3002, such as in the case where the heads up display is connected to a head protection device. Alternately, the display region 3004 along the side of the viewable area 3002 can be used alongside or in the absence of the upper display region 3004.

In an exemplary embodiment, the display regions 3004 present a binocular heads up display to the user of the safety device. The binocular display presents the displayed information to both of the user's eyes, removing a need for special corrective lenses or wearer adjustment. Also, the binocular view maintains a large percentage of natural vision of the surrounding environment.

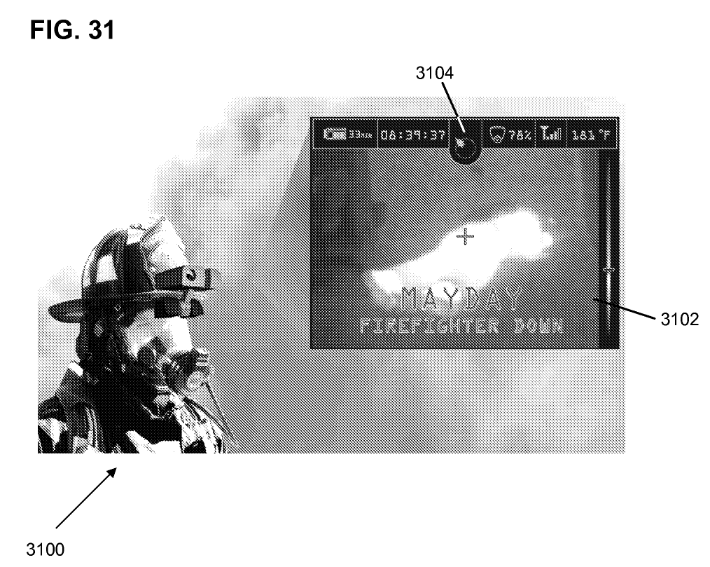

FIG. 31 illustrates an example user interface 3100 of a heads-up display integrated with a thermal imaging camera in a headwear-mountable situational awareness unit, according to a possible embodiment of the present disclosure. The user interface 3100 is displayed on a heads-up display of a headwear-mountable situational awareness unit, such as the unit 100 of FIGS. 1-28. The user interface 3100 illustrates a possible embodiment applying heads-up display technologies to the field of view discussed above in conjunction with FIG. 30.

The user interface 3100 includes a status bar 3102 and a main viewing area 3104. The status bar 3102 extends across a top portion and side portion of the overall viewable area in front of a user. The status bar 3102 displays various status information relating to the user of the heads-up display, such as the battery life, communicative connection, sensor readings, and other information communicated to or sensed by the unit including the heads-up display. In the embodiment shown, the sensed information can include thermal information sensed using a thermal imaging camera, such as an ambient temperature in an area near the heads-up display, change in temperature, or other thermal information. The main viewing area 3104 generally corresponds to the field of view of the user, and can include both a natural view of the user and an overlay presented by the heads up display. The overlay can include, among other elements, a thermal image or messages (e.g. warning conditions) received from computing systems or other communications units external to the system including the heads-up display.

FIG. 32 illustrates an example network 3200 in which one or more headwear-mountable situational awareness units can be used, according to a possible embodiment of the present disclosure. The network 3200 illustrates use of a safety device at an emergency site 3202, according to a possible embodiment of the present disclosure. A plurality of first responders 3204, 3204′ or other users at the emergency site 3202 wear the safety device, e.g. the situational awareness unit 100 of FIGS. 1-28, each of which can include a plurality of sensors and communication devices. The plurality of sensors can detect a number of personal and environmental conditions experienced by the first responder, such as a thermal image of a scene in front of the user, as described herein. The safety devices can each transmit and receive information from one or both of a digital communications source 3206 and an audio communications source 3208 via the communication devices. In another possible embodiment the digital communications source 3206 and/or the audio communications source 3208 can be incorporated into a computing system or communication system associated with and recognizable to the safety devices. In a possible embodiment, the digital communications source 3206 and/or the audio communications source 3208 can be incorporated into a second safety device (of the same or different type) worn by a different first responder 3204′. Integration of communications systems into the breathing apparatus provides a convenient way to communicate without requiring that the first responders 3204, 3204′ remove their head protection equipment or breathing apparatus.

In an exemplary embodiment, the digital communications source 3206 or audio communications source 3208 includes a mesh radio network configured to transmit messages between first responders at an emergency site 3202 and to a central emergency response coordination location (not shown).

In use, the first responders 3204, 3204′ communicate with each other and with the digital communications source 3206 and/or audio communications source 3208 about the condition of the emergency at their respective locations. For example, first responder 3204 can correspond to first responder 3204′ or other communicatively connected individuals about the situation experienced by that individual. The first responder 3204 can use an audio or digital communication system for voice or data/text communication. The first responder 3204′ receiving the message uses a complementary receiver/transmitter to receive and/or reply to the message.

Additionally, the first responders 3204, 3204′ optionally transmit information from the location of that responder to either the digital communications source 3206 or audio communications source 3208, for storage or transmission of that data. Other individuals not present at an emergency site, or more generally remote from a user of a device, can access one or both sources 3206, 3208 to observe transmitted information from a user, such as sensor information, video feeds, or other information. Alternately, one or more of the first responders 3204, 3204′ can receive information from the sources 3206, 3208 which is stored there by other first responders or users in general.

FIG. 33 illustrates a further example network 3300 in which one or more headwear-mountable situational awareness units can be used, according to a possible embodiment of the present disclosure. The network 3300 corresponds to an example mesh network that can be deployed at an emergency site or other area in which data and audio communication is desirable. The network 3300 includes one or more headwear-mountable situational awareness units 3302, communication nodes 3304, and command centers 3306. The headwear-mountable situational awareness units 3302 are generally associated with users, corresponding to the first responders and other workers at the emergency site. The communication nodes 3304 correspond to nodes of a mesh network, and can be deployed at various locations around an emergency site to establish a reliable, redundant communications network for transmitting information between first responders (e.g. police, fire personnel). The command center 3306 corresponds to a first responder and associated equipment (computing system, telecommunications devices, etc.) coordinating first response efforts.

In the network 3300, a variety of communication protocols can be used to communicate information among the headwear-mountable situational awareness units 3302, communication nodes 3304, and command centers 3306. Furthermore, a variety of numbers and communication arrangements of these elements are possible as well.

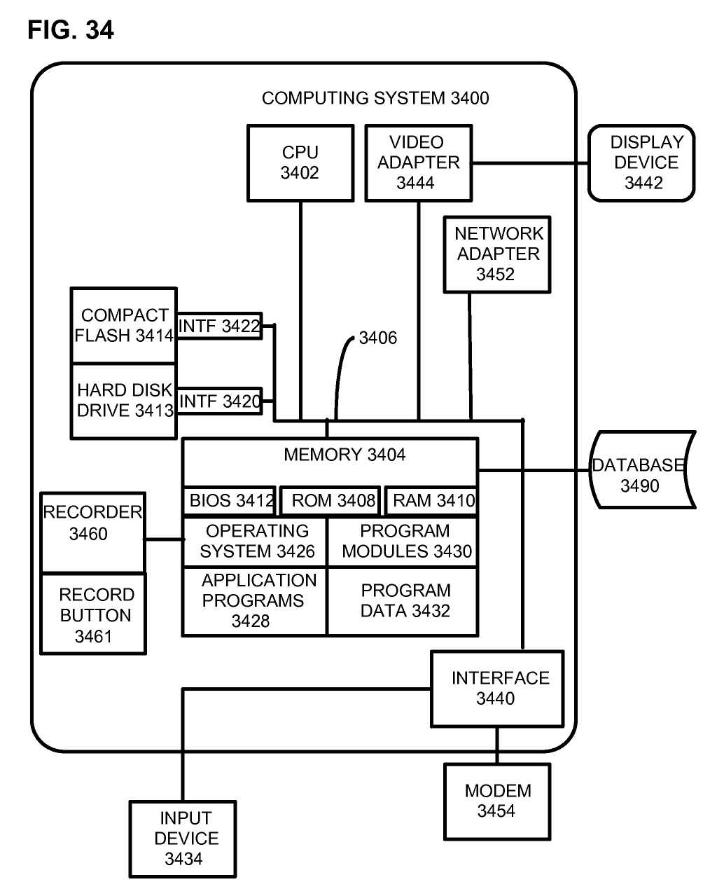

FIG. 34 is a block diagram of a generalized computing system usable to implement aspects of the present disclosure. The computing system 3400 can be used in communicative connection with the situational awareness unit 100 described above, as illustrated in FIGS. 1-28. The computing system architecture includes a general purpose computing device in the form of a computing system 3400. The computing system 3400 can be used, for example, as the computing system or server 3206 of FIG. 32, and can execute program modules included in the administrative software or user software disclosed below.

The computing system 3400 including at least one processing system 3402. A variety of processing units are available from a variety of manufacturers, for example, Intel or Advanced Micro Devices. The computing system 3400 also includes a system memory 3404, and a system bus 3406 that couples various system components including the system memory 3404 to the processing unit 3402. The system bus 3406 may be any of a number of types of bus structures including a memory bus, or memory controller; a peripheral bus; and a local bus using any of a variety of bus architectures.

The system memory 3404 can include read only memory (ROM) 3408 and random access memory (RAM) 3410. A basic input/output system 3412 (BIOS), containing the basic routines that help transfer information between elements within the computing system 3400, such as during start up, is typically stored in the ROM 3408.

The computing system 3400 can also include a secondary storage device 3413, such as a hard disk drive, for reading from and writing to a hard disk (not shown), and/or a compact flash card 3414.

The hard disk drive 3413 and compact flash card 3414 are connected to the system bus 3406 by a hard disk drive interface 3420 and a compact flash card interface 3422, respectively. The drives and cards and their associated computer readable media provide nonvolatile storage of computer readable instructions, data structures, program modules and other data for the computing system 3400.

Although the exemplary environment described herein employs a hard disk drive 3413 and a compact flash card 3414, other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), or read only memories (ROMs).

A number of program modules may be stored on the hard disk 3413, compact flash card 3414, ROM 3408, or RAM 3410, including an operating system 3426, one or more application programs 3428, other program modules 3430, and program data 3432. A user may enter commands and information into the computing system 3400 through an input device 3434. Examples of input devices might include a keyboard, mouse, microphone, joystick, game pad, satellite dish, scanner, digital camera, touch screen, and a telephone. These and other input devices are often connected to the processing unit 3402 through an interface 3440 that is coupled to the system bus 3406. These input devices also might be connected by any number of interfaces, such as a parallel port, serial port, game port, or a universal serial bus (USB). Wireless communication between input devices and interfaces 3440 is possible as well, and can include infrared, bluetooth, 802.11a/b/g, cellular, or other radio frequency communication systems. A display device 3442, such as a monitor or touch screen LCD panel, is also connected to the system bus 3406 via an interface, such as a video adapter 3444. The display device 3442 might be internal or external. In addition to the display device 3442, computing systems, in general, typically include other peripheral devices (not shown), such as speakers, printers, and palm devices.

When used in a LAN networking environment, the computing system 3400 is connected to the local network through a network interface or adapter 3452. When used in a WAN networking environment, such as the Internet, the computing system 3400 typically includes a modem 3454 or other communications type, such as a direct connection, for establishing communications over the wide area network. The modem 3454, which can be internal or external, is connected to the system bus 3406 via the interface 3440. In a networked environment, program modules depicted relative to the computing system 3400, or portions thereof, may be stored in a remote memory storage device. It will be appreciated that the network connections shown are exemplary and other methods of establishing a communications link between the computing systems may be used.

The computing system 3400 might also include a recorder 3460 connected to the memory 3404. The recorder 3460 includes a microphone for receiving sound input and is in communication with the memory 3404 for buffering and storing the sound input. The recorder 3460 also can include a record button 3461 for activating the microphone and communicating the sound input to the memory 3404.

Optionally, the computing system 3400 further includes a database 3490 configured to store one or more types of data, and can be configured to gather information from various sources connected to the system.

A computing device, such as computing system 3400, typically includes at least some form of computer-readable media. Computer readable media can be any available media that can be accessed by the computing system 3400. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 3400.

Communication media typically embodies computer-readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

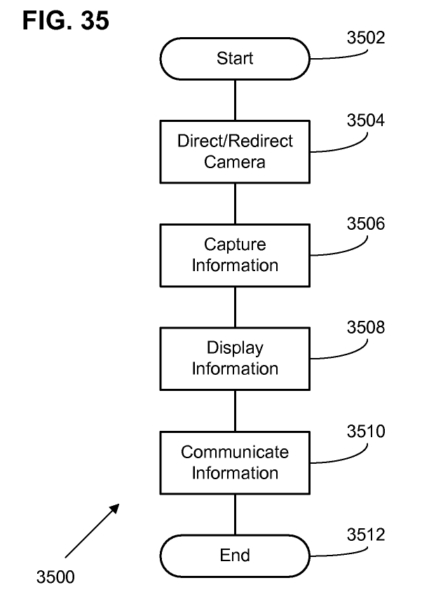

FIG. 35 illustrates a flowchart of methods and systems of use relating to a headwear-mountable situational awareness unit, according to a possible embodiment of the present disclosure. The methods and systems 3500 correspond, in certain embodiments, to use or operation of a headwear-mountable situational awareness unit, such as the unit 100 described in FIGS. 1-28, above.

The system 3500 is instantiated at a start operation 3502, which corresponds to initial use or operation of the headwear-mountable situational awareness unit, particularly while it is mounted on a piece of protective headwear. Operational flow proceeds to a positioning module 3504, which corresponds to positioning a thermal imaging camera such that it is oriented forward from a piece of protective headwear.

In certain embodiments, the positioning module 3504 corresponds to a user, who is wearing a piece of protective headgear on which the thermal imaging camera is mounted, manually positioning the thermal imaging camera such that the camera is directed straight ahead of that user. The user can have a default head position pointed straight ahead (e.g. typical upright position) or can be in a head-down, crawling position. In each case, the thermal imaging camera is rotatable to be oriented straight ahead of the user.

In certain further embodiments, the positioning module 3504 corresponds to a camera providing a capability to be manually or remotely repositioned, and receiving input in the form of manual movement or electronic instructions to be repositioned.

Operational flow proceeds to a capture module 3506, which corresponds to capturing a thermal image using the thermal image camera. The capture module 3506 causes the thermal image camera to capture information about the environment at which the camera is oriented. The information captured can include, for example, thermal images, current temperatures, and other temperature and image related information.

Operational flow proceeds to a display module 3508, which corresponds to displaying information relating to the thermal image on a heads-up display that forms a portion of the headwear-mountable situational awareness unit. The information can be, in various embodiments, displayed in a heads-up display portion of a user's field of view, or can be projected into the field of view in a semi-transparent manner, allowing the user to see the information without losing sight of his/her surroundings.

Operational flow proceeds to a communication module 3510, which corresponds to communication of information with the headwear-mountable situational awareness unit. This communication can take place in a variety of forms. For example, in certain embodiments, the communication module 3510 is configured to communicate thermal images or other information captured by the thermal imaging camera during operation of the capture module 3506. This information can be communicated to an external computing system, or to another user of a different headwear-mountable situational awareness unit. In further embodiments, the communication module 3510 can correspond to the headwear-mountable situational awareness unit receiving communication from a computing system or other headwear-mountable situational awareness unit. This communication can include information about other environmental conditions, commands, text messages, or other information. Once received, this information can also be displayed to the user, for example on the heads-up display of the headwear-mountable situational awareness unit.

Operational flow terminates at an end operation 3512, which corresponds to completed operation of the headwear-mountable situational awareness unit.

The above specification, examples and data provide a complete description of the manufacture and use of the composition of the invention. Since many embodiments of the invention can be made without departing from the spirit and scope of the invention, the invention resides in the claims hereinafter appended.

1. A headwear-mountable situational awareness unit comprising:
a thermal imaging camera rotatably connected to a mounting portion, the mounting portion connectable to a front portion of protective headgear; and
a heads-up display pivotally connected to the mounting portion, the heads-up display portion arranged to pivot at least between a mounted position and a handheld position and configured to display information captured by the thermal imaging camera.

2. The headwear-mountable situational awareness unit of claim 1, wherein the heads-up display is arranged to be positioned at a periphery of a user's field of view when in the mounted position.

3. The headwear-mountable situational awareness unit of claim 1, wherein the thermal imaging camera is manually rotatable with respect to the mounting portion.

4. The headwear-mountable situational awareness unit of claim 1, wherein the thermal imaging camera is configured to capture thermal images of an environment proximate to the thermal imaging camera.

5. The headwear-mountable situational awareness unit of claim 1, wherein, in the handheld position, the heads-up display is aligned with the thermal imaging camera and the mounting portion.

6. The headwear-mountable situational awareness unit of claim 1, further comprising a battery module incorporated within the mounting portion and capable of providing power to the heads up display and the thermal imaging camera.

7. The headwear-mountable situational awareness unit of claim 1, further comprising a communication module incorporated within the mounting portion.

8. The headwear-mountable situational awareness unit of claim 7, wherein the heads-up display is configured to display messages received by the communication module.

9. The headwear-mountable situational awareness unit of claim 7, wherein the communication module is configured to transmit information captured by the thermal imaging camera.

10. The headwear-mountable situational awareness unit of claim 1, wherein the mounting portion is shaped to be mounted to a fire helmet.

11. The headwear-mountable situational awareness unit of claim 1, wherein the thermal imaging camera includes a temperature sensor configured to detect warning conditions near the user.

12. The headwear-mountable situational awareness unit of claim 11, wherein the heads-up display is configured to display the warning conditions to the user.

13. The headwear-mountable situational awareness unit of claim 1, wherein the thermal imaging camera is rotatable through a vertical arc of approximately 90 degrees.

14. The headwear-mountable situational awareness unit of claim 1, wherein the mounting portion is detachable from the protective headgear to allow handheld use of the unit.

15. The headwear-mountable situational awareness unit of claim 1, wherein the heads-up display is a binocular heads-up display.

16. The headwear-mountable situational awareness unit of claim 1, further comprising a communications port in the mounting portion configured to communicatively connect to a communications module external to the headwear-mountable situational awareness unit.

17. A method of operation of a situational awareness unit, the method comprising:
directing a thermal image camera toward an area in front of a user, the thermal image camera rotatably connected to a mounting portion mounted on protective headgear worn by the user;
capturing a thermal image of the area in front of the user with the thermal image camera; and
displaying information relating to the thermal image in a heads-up display connected to the mounting portion.

18. The method of claim 17, further comprising communicating the thermal image to a remote computing system via a communication interface incorporated in the mounting portion.

19. The method of claim 17, further comprising:
receiving information from a remote computing system; and
displaying the information on the heads-up display.

20. The method of claim 17, further comprising manually repositioning the thermal image camera by rotating the thermal image camera with respect to the mounting portion.

21. The method of claim 17, further comprising removing the thermal image camera and the heads-up display from the protective headgear for use in a handheld position.

22. A headwear-mountable situational awareness unit comprising:
a mounting portion connectable to a front portion of protective headgear and including a housing, the mounting portion enclosing circuitry and defining a communications port connectable to an external communications module;
a thermal imaging camera connected to the mounting portion, the thermal imaging camera manually rotatable with respect to the mounting portion; and
a heads-up display pivotally connected to the mounting portion, the heads-up display portion arranged to pivot at least between a mounted position and a handheld position and configured to display information captured by the thermal imaging camera.
